(19) United States
(12) Patent Application Publication
(10) Pub. No.: US 2018/0176173 A1
(43) Pub. Date: Jun. 21, 2018

(54) DETECTING EXTRANEOUS SOCIAL MEDIA MESSAGES

(71) Applicant: Google Inc., Mountain View, CA (US)

(72) Inventors: Daniel Martin Keysers, Stallikon (CH); Thomas Deselaers, Zurich (CH); Victor Carbune, Basil (CH)

(21) Appl. No.: 15/380,748

(22) Filed: Dec. 15, 2016

(51) Int. Cl. H04L 12/58; G06N 7/00; G06N 99/00

(52) U.S. Cl. CPC H04L 51/32; H04L 51/063; G06N 99/005; G06N 7/005; H04L 51/16

(57) ABSTRACT

A social network server system may receive a social media message that is to be posted at the social network server system, the social media message being authored by a user of the social network server system. Prior to posting the social media message at the social network server system, the social network server system may determine, based at least in part on applying one or more rules to content of the social media message, a likelihood that the user would modify the content of the social media message after it is posted at the social network server system, wherein the one or more rules are generated based at least in part on previous actions taken by the user on previous social media messages authored by the user and posted at the social network server system and may, responsive to determining that the likelihood exceeds a threshold, generate an alert message.

### BACKGROUND

A social media network running on a computing system may enable users of the social media network to post social media messages that may be viewed by other users of the social media network. A user, after posting a social media message, may, at a later time, choose to delete the social media message or to modify the contents of the social media message.

### SUMMARY

Aspects of the present disclosure relate to techniques for generating an alert at a computing system to indicate that content of a social media message that is to be posted at a social network server system may include offensive or embarrassing content, or personally sensitive content, and enabling a user to modify or delete the message prior to its being posted, or to otherwise refrain from allowing the message to be posted at the social network server system. Because these techniques may cause social network server system to refrain from posting certain messages that a user is likely to subsequently delete, the techniques may decrease the amount of processing for of messages by social network server system (e.g., messages that are posted and then subsequently deleted), thereby potentially improving the performance of the social network server system.

In one aspect, the disclosure is directed to a method. The method includes receiving, by a social network server system, a social media message that is to be posted at the social network server system, the social media message being authored by a user of the social network server system. The method further includes, prior to posting the social media message at the social network server system: determining, by the social network server system, and based at least in part on applying one or more rules to content of the social media message, a likelihood that the user would modify the content of the social media message after it is posted at the social network server system, wherein the one or more rules are generated based at least in part on previous actions taken by the user on previous social media messages authored by the user and posted at the social network server system; and responsive to determining that the likelihood exceeds a threshold, generating, by the social network server system, an alert message.

In another aspect, the disclosure is directed to a social network server system. The social network server system includes a memory. The social network server system further includes at least one processor communicatively coupled to the memory, the at least one processor being configured to receive a social media message that is to be posted at the social network server system, the social media message being authored by a user of the social network server system. Prior to posting the social media message at the social network server system, the at least one processor is configured to: determine, based at least in part on applying one or more rules stored in the memory to content of the social media message, a likelihood that the user would modify the content of the social media message after it is posted at the social network server system, wherein the one or more rules are generated based at least in part on previous actions taken by the user on previous social media messages authored by the user and posted at the social network server system; and responsive to determining that the likelihood exceeds a threshold, generate an alert message.

In another aspect, the disclosure is directed to a non-transitory computer readable medium encoded with instructions. The instructions, when executed, cause one or more processors of a computing device to receive a social media message that is to be posted at the social network server system, the social media message being authored by a user of the social network server system. The instructions further cause the one or more processor to, prior to posting the social media message at the social network server system: determine, based at least in part on applying one or more rules to content of the social media message, a likelihood that the user would modify the content of the social media message after it is posted at the social network server system, wherein the one or more rules are generated based at least in part on previous actions taken by the user on previous social media messages authored by the user and posted at the social network server system; and responsive to determining that the likelihood exceeds a threshold, generate an alert message.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example computing device and graphical user interfaces (GUIs) that may be configured to send a request to post a social media message at an example social network server system, the social network server system being configured to determine whether a user that authored the social media message is likely to later modify the social media message, in accordance with one or more techniques of the present disclosure.

FIG. 2 is a block diagram illustrating details of one example of a social network server system that may be configured to determine whether a user that authored a social media message is likely to later modify the social media message, in accordance with one or more techniques of the present disclosure.

FIG. 3 is a flow diagram illustrating example operations of a social network server system that may be configured to determine whether the user that authored the social media message is likely to later modify the social media message, in accordance with one or more techniques of the present disclosure.

### DETAILED DESCRIPTION

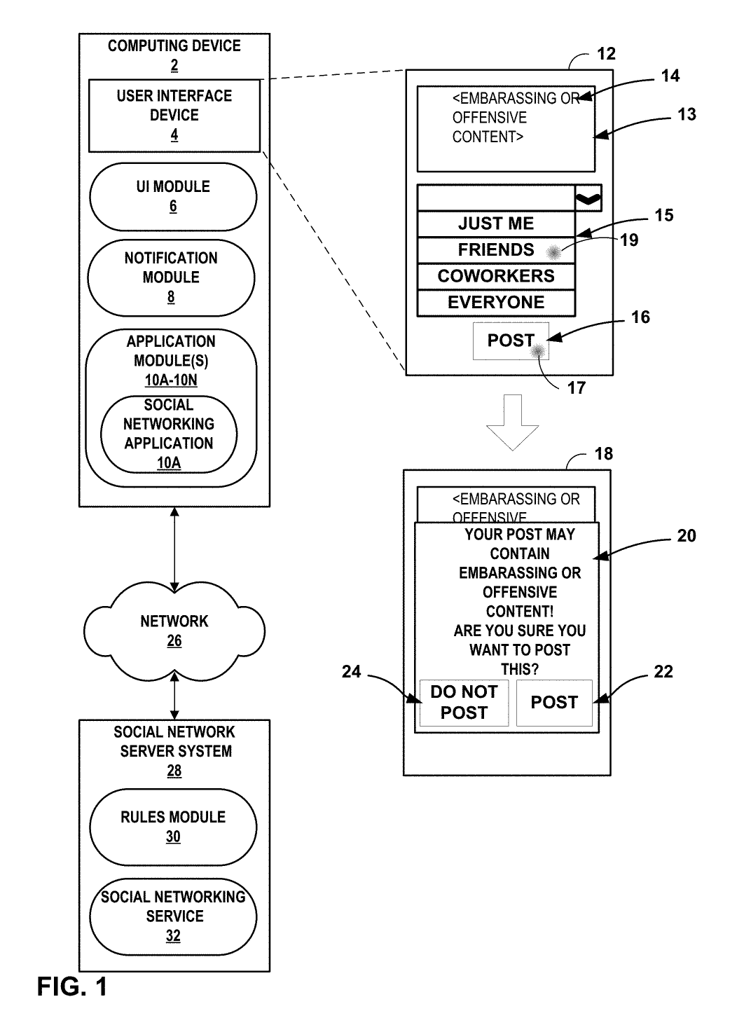

FIG. 1 is a block diagram illustrating an example computing device 2, social network server system 28, and graphical user interfaces (GUIs) 12 and 18 for sending a request to post a social media message to social networking service 32 of social network server system 28, where social networking service 32 of social network server system 28 may be configured to determine the likelihood that a user who authored the social media message would later modify the contents of the social media message after it is posted at social network server system 28, in accordance with one or more techniques of the present disclosure. As shown in FIG. 1, computing device 2 may communicate with social network server system 28 via network 26 to interact with social networking service 32 provided by social network server system 28. A user may interact with the social networking service 32 via interaction with a social networking application 10A that executes on computing device 2, where social networking application 10A may post content to social networking service 32. The user may view content posted at social networking service 32 by computing devices associated with the user's social networking contacts. Social networking application 10A may communicate with social networking service 32 of social network server system 28 via network 26 to send and receive data in accordance with the user's interactions with the social networking application 10A.

Network 26 may be any public or private communications network, such as the Internet, a cellular data network, dialup modems over a telephone network, a private local area network (LAN), leased lines, or a combination of such communication networks. Network 26 may include one or more network switches, network hubs, network routers, modems, or any other suitable network equipment that are operably intercoupled to provide for the exchange of information between social network server system 28 and computing device 2. Network 26 may be a wired network or a wireless network.

Computing device 2 and social network server system 28 may transmit and receive data across network 26 using any suitable communication techniques. Computing device 2 and social network server system 28 may each be operably coupled to network 26 using respective network links. The links coupling computing device 2 and social network server system 28 to network 26 may include Ethernet, asynchronous transfer mode (ATM) networks, or other suitable types of wired and/or wireless network connection.

In some examples, social network server system 28 may be a single computing device such as a computing server. In other examples, social network server system 28 may be implemented by multiple computing devices or systems working to perform the actions of a server system (e.g., cloud computing).

Examples of computing device 2 may include, but are not limited to, portable, mobile, or other devices, such as mobile phones (including smartphones), wearable devices (including smart watches), laptop computers, desktop computers, tablet computers, smart television platforms, personal digital assistants (PDAs), server computers, mainframes, and the like.

Computing device 2, as shown in the example of FIG. 1, includes user interface (UI) device 4. UI device 4 of computing device 2 may be configured to function as an input device and/or an output device for computing device 2. UI device 4 may be implemented using various technologies. For instance, UI device 4 may be configured to receive input from a user through tactile, audio, and/or video feedback. Examples of input devices include a presence-sensitive display, a presence-sensitive or touch-sensitive input device, a mouse, a keyboard, a voice responsive system, video camera, microphone or any other type of device for detecting a command from a user. In some examples, a presence-sensitive display includes a touch-sensitive or presence-sensitive input screen, such as a resistive touchscreen, a surface acoustic wave touchscreen, a capacitive touchscreen, a projective capacitance touchscreen, a pressure-sensitive screen, an acoustic pulse recognition touchscreen, or another presence-sensitive technology. That is, in some cases, UI device 4 of computing device 2 may include a presence-sensitive device that may receive tactile input from a user of computing device 2. UI device 4 may receive indications of the tactile input by detecting one or more gestures from the user (e.g., when the user touches or points to one or more locations of UI device 4 with a finger or a stylus pen).

UI device 4 may additionally or alternatively be configured to function as an output device by providing output to a user using tactile, audio, or video stimuli. Examples of output devices include a sound card, a video graphics adapter card, or any of one or more display devices, such as a liquid crystal display (LCD), dot matrix display, light emitting diode (LED) display, organic light-emitting diode (OLED) display, e-ink, or similar monochrome or color display capable of outputting visible information to a user of computing device 2. Additional examples of an output device include a speaker, a cathode ray tube (CRT) monitor, a liquid crystal display (LCD), or other device that can generate intelligible output to a user. For instance, UI device 4 may present output to a user of computing device 2 as a graphical user interface that may be associated with functionality provided by computing device 2. In this way, UI device 4 may present various user interfaces of applications executing at or accessible by computing device 2 (e.g., an electronic message application, an Internet browser application). A user of computing device 2 may interact with a respective user interface of an application to cause computing device 2 to perform operations relating to a function.

In some examples, UI device 4 of computing device 2 may detect two-dimensional and/or three-dimensional gestures as input from a user of computing device 2. For instance, a sensor of UI device 4 may detect the user's movement (e.g., moving a hand, an arm, a pen, a stylus) within a threshold distance of the sensor of UI device 4. UI device 4 may determine a two or three-dimensional vector representation of the movement and correlate the vector representation to a gesture input (e.g., a hand-wave, a pinch, a clap, a pen stroke) that has multiple dimensions. In other words, UI device 4 may, in some examples, detect a multi-dimension gesture without requiring the user to gesture at or near a screen or surface at which UI device 4 outputs information for display. Instead, UI device 4 may detect a multi-dimensional gesture performed at or near a sensor which may or may not be located near the screen or surface at which UI device 4 outputs information for display.

In the example of FIG. 1, computing device 2 includes user interface (UI) module 6, and/or application modules 10A-10N (collectively “application modules 10). Modules 6 and/or 10 may perform one or more operations described herein using hardware, software, firmware, or a mixture thereof residing within and/or executing at computing device 2. Computing device 2 may execute modules 6 and/or 10 with one processor or with multiple processors. In some examples, computing device 2 may execute modules 6 and/or 10 as a virtual machine executing on underlying hardware. Modules 6 and/or 10 may execute as one or more services of an operating system or computing platform or may execute as one or more executable programs at an application layer of a computing platform.

UI module 6, as shown in the example of FIG. 1, may be operable by computing device 2 to perform one or more functions, such as receive input and send indications of such input to other components associated with computing device 2, such as modules 10. UI module 6 may also receive data from components associated with computing device 2, such as modules 10. Using the data received, UI module 6 may cause other components associated with computing device 2, such as UI device 4, to provide output based on the received data. For instance, UI module 6 may receive data from one of application modules 10 to display a GUI.

Application modules 10, as shown in the example of FIG. 1, may include functionality to perform any variety of operations on computing device 2. For instance, application modules 10 may include a word processor, an email application, a chat application, a messaging application, a social networking application, a web browser, a multimedia player, a calendar application, an operating system, a distributed computing application, a graphic design application, a video editing application, a web development application, or any other application. In some examples, one or more of application modules 10 may be operable to interact with social network service 32 provided by social network server system 28.

For instance, one of application modules 10 (e.g., application module 10A) may be social networking application 10A. Social networking application 10A may be any application or process executing on computing device 2 that may be able to interact with a social networking service 32 provided by social network server system 28. Examples of a social networking application 10A include an app (e.g., a social network app on a smart phone), a web browser, a widget, a system-level process, and the like.

Social networking application 10A may include functionality to interact with the social networking service 32 provided by social network server system 28. Such functionality may include the ability to compose and post social media messages to social networking service 32, receive social media messages posted by other users of social networking service 32, respond to social media messages posted by other users of social networking service 32, and the like. Social media messages may be content that is posted by users onto social networking service 32 to be viewed or otherwise consumed by other users of social networking service 32. Such content may include any combination of text, images, videos, audio, animations, web links, icons, emojis, and the like. Examples of social media messages may include a message containing textual content and/or audiovisual content that may be posted at social networking service 32 and that is viewable by one or more other users of social networking service 32, a status update, comments to social media messages posted by other users of social networking service 32, a restaurant review posted to a social restaurant review website, and the like.

In the example of FIG. 1, social networking application 10A may be operable to receive content authored or otherwise generated or included by a user of computing device 2 for posting to social networking service 32. Social networking application 10A may cause one or more other components of computing device 2 to output a GUI (e.g., for display to a user of computing device 2) with which the user may interact to input or otherwise provide content for posting to social networking service 32. That is, social networking application 10A may send data to UI module 6 to cause UI device 4 to display GUI 12.

GUI 12 may be the graphical user interface of social networking application 10A executing at computing device 2. As shown in FIG. 1, GUI 12 may include content area 13, audience selector 15, and post button 16. Content area 13 may be an area within GUI 12 into which the user may input or compose content 14 such as text, images, videos, and the like to compose a social media message containing content 14 that is to be posted to social networking service 32.

Audience selector 15 may be a widget or GUI control that enables the user to select the intended audience for the social media message. The intended audience may indicate the user or users of social network service 32 to whom the social media message will be visible when the social media message is posted to social networking service 32. In the example of FIG. 1, the user may utilize audience selector 15 to select amongst intended audiences of “just me,” “friends,” “coworkers,” and “everyone.” The intended audience of “just me” may include only the user that is posting the social media message. The intended audience of “everyone” may include every user of social networking service 32. Thus, if the user selects “just me” via audience selector 15, the social media message may only be visible to the user when viewed on social networking service 32. Further, if the user selects “everyone” via audience selector 15, the social media message may be visible to every user of social networking service 32 when viewed on social networking service 32.

The intended audiences of “friends” and “coworkers” may each include a different group of users of social networking service 32. For example, the user may select the users of social networking service 32 making up the intended audiences of “friends” and “coworkers.” In some examples, there may be one or more users of social networking service 32 who belong to both “friends” and “coworkers.” In some examples, there may be one or more users of social networking service 32 who belong to just one of “friends” and “coworkers.” In some examples, there may be one or more users of social networking service 32 who don't belong to either “friends” or “coworkers.” The intended audiences illustrated in FIG. 1 are just some non-exhaustive examples of groupings of users of social networking service 32, and that in other examples the user may select amongst other, different groupings of users of social networking service 32 as the intended audience of a social media message.

GUI 12 may include more elements or fewer elements than what is shown in FIG. 1. For example, computing device 2 may receive an indication of textual input via input provided by a user at a graphical keyboard in GUI 12 to form textual portions of content 14 of the social media message to be posted to social networking service 32. Similarly, computing device 2 may receive an indication of input that instructs computing device to select images, videos, audio files, and the like to include in content 14 of the social media message. As such, the user may interact with GUI 12 to input content 14 of a social media message to be posted to social networking service 32.

In the example of FIG. 1, the user has authored or otherwise inputted potentially embarrassing or offensive content as content 14 of a social media message. A social media message may be any content created by a user that may be shared via social networking service 32. Examples of social media messages may include social media updates, comments to social media updates posted by other users, replies made to comments of other users at social networking service 32, restaurant reviews, location check-ins, and the like. As discussed above, content 14 of a social media message may include text, images, videos, and the like. In the example, the user has also used intended audience selector 15 to select the intended audience of “friends” as the intended audience for the social media message.

Computing device 2 may receive an indication of input that instructs computing device 2 to post content 14 to social network service 32. To that end, the user may select post button 16. For instance, the user of computing device 2 may perform input 17 at UI device 4 to tap or otherwise select post button 16. UI device 4 may detect input 17 and send an indication of the input to UI module 6. UI module 6 may provide data to social networking application 10A based on the received indication, and social networking application 10A may determine that input 17 corresponds to a selection of post button 16.

Responsive to receiving data indicating a user's selection of post button 16 (e.g., an indication of input 17), social networking application 10A may communicate with social network server system 28 via network 26 to send to social network server system 28 a request to post a social media message that includes content 14 to social networking service 32. Social networking application 10A may communicate data, such as an indication of content 14 of the social media message along with indications of contextual information associated with social media message, to social network server system 28 of social network server system 28 as part of the request. Such contextual information may include but is not limited to an indication of the user that is attempting to post the social media message, an indication of the time and date at which the user is attempting to post the social media message, an indication of the geographic location of the user, an indication of computing device 2 from which the user is attempting to post the social media message, an indication of the intended audience of the social media message, an indication of the activity in which computing device 2 has inferred that the user is taking part, and the like.

As shown in FIG. 1, social network server system 28 may include rules module 30 and social networking service 32. Social network server system 28 may receive the request to post the social media message from social networking application 10A of computing device 2 through network 26. Prior to posting the social media message at social networking service 32, social networking service 32 may utilize rules module 30 to apply one or more rules to content 14 of the social media message included as part of the request to determine whether to generate and send an alert to computing device 2 to warn the user that the social media message may potentially include offensive or embarrassing content, personally sensitive content, and the like.

To determine whether to generate and send an alert to computing device 2 to warn the user that the social media message may potentially include offensive, embarrassing, or personally sensitive content, social networking service 32 may determine a likelihood that the user would modify content 14 of the social media message after it is posted at social networking service 32. Modifying content 14 of the social media message may include editing content 14 to remove some portions (but not all) of content 14 that are deemed to include offensive, embarrassing, or personally sensitive content, editing content 14 to replace those portions of content 14 with additional content (e.g., replacing a sentence in the social media message with a different sentence or replacing an image in the social media message with a different image), or deleting social media message 14. Thus, modifying a social media message may include editing content 14 to replace at least a portion of content 14 or deleting the social media message.

The user may be highly likely to, after a posting a social media message, modify the posted social media message if it contains content 14 that is, e.g., offensive, embarrassing, or otherwise casts the user in a negative light, or to edit the social media message to remove or replace such offensive or embarrassing portions of content 14. Thus, social networking service 32 may determine, prior to posting the social media message, a likelihood that the user would, after posting the social media message to social networking service 32, modify content 14 of the social media message as a proxy to determine whether the social media message contains content 14 that is potentially offensive, embarrassing, or otherwise casts the user in a negative light, or whether the social media message contains personally sensitive information (e.g., credit card numbers, social security numbers, passwords, and the like) that the user would not like to be made publicly available to other users of social networking service 32.

To that end, social networking service 32 may utilize rules module 30 to analyze the social media message against a set of rules. The set of rules may specify characteristics of social media messages that may indicate that these social media messages may be more likely to be modified (e.g., deleted) by the authors of the social media messages after the social media messages have been posted to social networking service 32.

The set of rules may specify characteristics of the content (e.g., content 14) of social media messages that may indicate that these social media messages may be more likely to be deleted after the social media messages have been posted to social networking service 32. For example, if the content of a social media message includes certain words (e.g., swear words), or includes a picture where at least 90% of the pixels of the picture have the color of human flesh, then these characteristics may indicate that the social media message may be relatively more likely to be modified after it has been posted to social networking service 32.

The set of rules may also specify characteristics of social media messages, other than the characteristics of the content of social media messages, that may indicate that these social media messages may be more likely to be modified after the social media messages have been posted to social networking service 32. Such characteristics of social media messages may include the time at which the social media message was composed, the geographic location of computing device 2 at which the social media message was composed, and the like. For example, if social networking service 32 receives a request to post a social media message that was composed between midnight and 8 am, and if the geographic location of computing device at which the social media message was composed corresponds to a bar or a dance club, then these characteristics may indicate that the social media message may be relatively more likely to be modified after it has been posted.

In some examples, the rules that are applied to social media messages to determine the likelihood that the user would modify content 14 of the social media message after it is posted at social networking service 32 may depend at least in part on the intended audience of the social media message. For example, if the intended audience includes only the user who authored the social media message, rules module 30 may not apply any of the rules and may not determine whether the user would modify content 14 of the social media message after it is posted at social networking service 32. In another example, if the intended audience includes users that are deemed to be friends of the user, rules module 30 would refrain from applying rules regarding swear words to content 14 of the networking service 32. In contrast, if the intended audience includes users that are deemed to be co-workers of the user, rules module 30 would apply rules regarding swear words to content 14 of the networking service 32. Thus, the set of rules that are applied to the social media message may depend at least in part on the intended audience of the social media message.

The set of rules that rules module 30 may apply to social media messages can be generated in several ways. The set of rules may include one or more rules that are manually created, such as by administrators of social networking service 32 or other suitable authors of these rules. Administrators of social networking service 32 or other suitable authors may author rules by specifying characteristics of a social media message (e.g., specific words or phrases included in the content) that may indicate that the social media message may be relatively more likely to be deleted.

The set of rules may also include one or more rules that rules module 30 that are generated based on previous actions of the user that authored the social media message. Rules module 32 may generate the one or more rules based on previous social media messages that were posted and then later modified by the user. For example, rules module 30 may perform machine learning over those previous social media messages to learn the common characteristics of those previous social media messages that may signal or indicate to rules module 30 that the user may be highly likely to modify the social media messages. As discussed above, social networking service 32 may determine the likelihood that the user, after posting the social media message to social networking service 32, would modify content 14 of the social media message as a proxy to determine whether the social media message contains content 14 that is potentially offensive, embarrassing, or otherwise casts the user in a negative light. Thus, by analyzing the set of social media messages that were posted and then later modified by the user, rules module 30 may be able to determine common characteristics of those posts that may signal or indicate to rules module 30 that the user may be highly likely to modify the social media messages having at least some of those common characteristics after posting.

Rules module 30 may employ machine learning over a set of social media messages that were posted and then later deleted by the user to train a model based on those social media messages. In this way, rules module 30 may determine common characteristics of those previously posted and then modified social media messages and generate rules based on those common characteristics as determined by rules module 30. Rules module 30 may input a social media message into the machine-trained module and, in response, the machine-trained model may output the likelihood that the user would modify content 14 of the social media message after it is posted at social networking service 32.

The set of rules used by rules module 30 may also include one or more rules that rules module 30 may generate based on social media messages that were posted and then later modified by a plurality of users of social network service 32. In this instance, instead of analyzing just the set of social media messages that were posted and then later modified by an individual user, rules module 30 may employ machine learning over a set of social media messages that were posted and then later modified by a respective plurality of users of social networking service 32 to determine common characteristics of those previously posted and later modified social media messages, and to generate rules based on those common characteristics as determined by rules module 30. The social media messages that were posted and then later modified by users of social network service 32 may also include social media messages authored by the user that were previously determined to include content that is potentially offensive, embarrassing, or otherwise casts one or more users in a negative light, which the one or more users decided not to post to social networking service 32 upon such a determination.

Rules module 30 may generate a score for the social media message based at least in part on applying the set of rules to the social media message. Such a score may correspond with the likelihood that that the user, after posting the post, will modify the content of the post. If the score for the social media message exceeds a likelihood threshold, then social networking service 32 may determine that the likelihood that the user, after posting the post, will modify the content of the post also exceeds the likelihood threshold.

In the example where a rule specifies a set of swear words, rules module 30 may generate a score for the social media message that exceeds the likelihood threshold if content 14 of the social media message includes just one of the set of swear words specified by the rule. In another example, rules module 30 may generate a score for the social media message that does not exceed the likelihood threshold if content 14 of the social media message includes just one of the set of swear words specified by the rule, but may generate a score for the social media message that exceeds the likelihood threshold if content 14 of the social media message includes more than a determined number of the set of swear words specified by the rule. In other examples, rules module 30 may apply a set of rules to generate respective scores for the social media message, where the score generated by applying a single rule does not exceed the likelihood threshold, but where the aggregated score from applying multiple rules from the set of rules to the social media message does exceed the likelihood threshold. It should be understood that the examples above are just some of the possible ways to determine a score for the social media message based on applying a set of rules, and that any other suitable techniques for applying a set of rules to a social media message to generate a score for the social media message may be equally applicable.

In response to determining that the likelihood that the user would modify the content of the social media message surpasses a threshold, social networking service 32 may refrain from posting the social media message at social networking service 32 and may generate an alert message. The alert message may indicate that social networking service 32 has determined that the likelihood that the user would modify the content of the social media message after it is posted at social networking service 32 surpasses a likelihood threshold. In some examples, the alert message may identify the social media message. The alert message may also identify specific portions of content 14 that social networking service 32 has identified as containing possibly embarrassing, offensive, and/or personally sensitive content.

Social networking service 32 may communicate an indication of the alert message to social networking application 10A executing at computing device 2 via network 28. In response to receiving the indication of the alert message from social networking service 32, social networking application 10A may notify the user of the alert message by outputting a notification, a message, and the like for display. Social network application 10A may cause one or more components of computing device 2 to output a notification, a message, and the like (e.g., for display to a user of computing device 2) that indicates social networking application 10A has received such an alert from social networking service 32. Social networking application 10A may send data to UI module 6 to cause UI device 4 to display GUI 18. As shown in the example of FIG. 1, GUI 18 includes message 20 that indicates to the user of computing device 2 that the social media message the user attempted to post to social networking service 32 may contain potentially embarrassing or offensive content. In some examples, message 20 may also identify specific portions of content 14 that social networking service 32 has identified as containing possibly embarrassing or offensive content.

Social networking application 10A may also send data to UI module 6 to cause UI device 4 to display to display “post” button 22 and “do not post” button 24. If UI device 4 detects an input that selects “post” button 22, UI module 6 may provide data to social networking application 10A based on the received indication, and social networking application 10A may determine that the input detected by UI device 4 corresponds to a selection of “post” button 22. In response to receiving data indicating that the user has selected “post” button 22, social networking application 10A may communicate with social networking server system 28 via network 26 to send a confirmation that the user would like to post the social media message to social networking service 32.

If UI device 4 detects an input that selects “do not post” button 24, UI module 6 may provide data to social networking application 10A based on the received indication, and social networking application 10A may determine that the input detected by UI device 4 corresponds to a selection of “do not post” button 24. In response to receiving data indicating that the user has selected “do not post” button 24, social networking application 10A may communicate with social networking server system 28 via network 26 to send a confirmation that the user would like to refrain from posting the social media message to social networking service 32.

Alternatively, in response to receiving data indicating that the user has selected “do not post” button 24, social networking application 10A may refrain from further communications with social networking service 32 with respect to the social media message. For example, social networking application 10A may discard the social media message or may save the social media message (such as into a drafts folder) for the user to, at a later time, consider whether to post the social media message.

Further, in response to receiving data indicating that the user has selected “do not post” button 24, social networking application 10A may also provide the user an opportunity to edit content 14 of the social media message to delete or modify portions of content 14 that social networking service 32 has identified as having potentially embarrassing or offensive content. If social networking application 10A receives an alert from social networking service 32 that identifies portions of content 14 as containing possibly embarrassing or offensive content, social networking application 10A may highlight those identified portions of content 14. For example, social networking application 10A may send data to UI module 6 to cause UI device 4 to visually emphasize (e.g., visually highlight) those portions of content 14.

By determining that a user is attempting to post a social media message onto a social networking service (e.g., social networking service 32), which the user is likely to delete or otherwise modify after it has been posted to the social networking service, and by generating an alert notifying the user of such a determination, the techniques disclosed herein may reduce the amount of processing required by the computer system (e.g., social network server system 28) at which the social networking service executes. For example, the techniques herein may reduce the number of extraneous social media messages that are posted to the social networking service, thereby reducing the amount of processing required by the computer system to post social media messages and to propagate the social media messages across the social network. The techniques herein may also reduce the amount of processing required by the computer system to process the deletion of such extraneous social media messages. As such, the techniques disclosed herein may potentially improve the performance of the social networking service executing at the computer system.

Further, the techniques disclosed herein include applying a set of rules to the content of a social media message to determine whether the user is likely to delete or otherwise modify after it has been posted to the social networking service. By generating one or more of the rules based on previous social media messages that the user had posted and then later deleted, the techniques disclosed herein may more accurately identify those social media messages that are likely to be deleted after being posted to the social networking service. By more accurately identifying those social media messages that are likely to be deleted or otherwise modified after being posted to the social networking service, the social networking service may potentially reduce the number of alerts that it generates and sends over the network for false positives, as well as the number of requests it receives over the network to delete those social media messages, thereby reducing the amount of traffic over the network (e.g., network 26).

In addition, by identifying those social media messages that are likely to be deleted or otherwise modified after being posted to the social networking service, the techniques disclosed herein may enable the user or users authoring those identified social media messages to refrain from posting those social media messages to the social networking service. By not posting those social media messages that are identified as being likely to be deleted or otherwise modified after posting, the user or users may not have to further interact with the social networking application (e.g., social networking application 10A) to delete those social media messages. By potentially reducing the number of times the user or users may have to interact with the social networking application, the techniques disclosed herein may enable the computing device that executes the social networking application (e.g., computing device 2) to reduce the number of processing cycles expended to execute the social networking application and therefore its power usage. Such power usage preservation may be useful if the computing device is a mobile computing device that may primarily utilize battery power. As such, the techniques disclosed herein may improve the functioning of a computer or computer system itself (e.g., social network server system 28, computing device 2) in any number of ways.

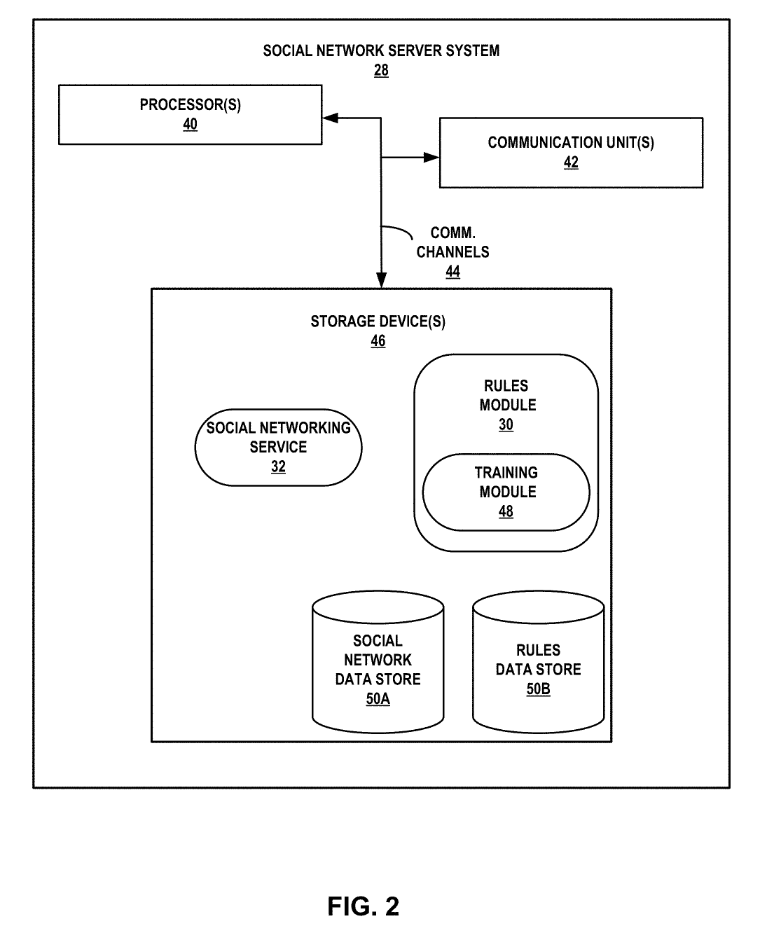

FIG. 2 is a block diagram illustrating details of one example of social network server system 28 that may be configured to determine whether a user that authored a social media message is likely to later modify the social media message, in accordance with one or more techniques of the present disclosure. FIG. 2 is described below within the context of FIG. 1. FIG. 2 illustrates only one particular example of social network server system 28, and many other example devices having more, fewer, or different components may also be configurable to perform operations in accordance with techniques of the present disclosure.

While displayed as part of a single device in the example of FIG. 2, components of social network server system 28 may, in some examples, be located within and/or be a part of different devices. For instance, in some examples, social network server system 28 may represent a “cloud” computing system. Thus, in these examples, the modules illustrated in FIG. 2 may span across multiple computing devices. In some examples, social network server system 28 may represent one of a plurality of servers making up a server cluster for a “cloud” computing system.

As shown in the example of FIG. 2, social network server system 28 includes one or more processors 40, one or more communications units 42, and one or more storage devices 46. Storage devices 46 further include social media module 32, rules module 30, social network data store 50A, and rules data store 50B. Rules module 30, in the example of FIG. 2, includes training module 48.

Each of components 40, 42, and 46 may be interconnected (physically, communicatively, and/or operatively) for inter-component communications. In the example of FIG. 2, components 40, 42, and 46 may be coupled by one or more communications channels 44. In some examples, communications channels 44 may include a system bus, network connection, inter-process communication data structure, or any other channel for communicating data. Social networking service 32, rules module 30, and training module 48 may also communicate information with one another as well as with other components in computing device 2.

In the example of FIG. 2, one or more processors 40 may implement functionality and/or execute instructions within social network server system 28. For example, one or more processors 40 may receive and execute instructions stored by storage devices 46 that execute the functionality of modules 30 and 48 and social networking service 32. These instructions executed by one or more processors 40 may cause social network server system 28 to store information within storage devices 46 during execution. One or more processors 40 may execute instructions of modules 30 and 48 and social networking service 32 to determine the likelihood that a user would modify the content of the social media message after it is posted at the social network server system. That is, modules 30 and 48 and social networking service 32 may be operable by one or more processors 40 to perform various actions or functions of social network server system 28 described herein.

In the example of FIG. 2, one or more communication units 42 may be operable to communicate with external devices (e.g., computing device 2) via one or more networks (e.g., network 26) by transmitting and/or receiving network signals on the one or more networks. For example, social network server system 28 may use communication units 46 to transmit and/or receive radio signals on a radio network such as a cellular radio network. Likewise, communication units 42 may transmit and/or receive satellite signals on a satellite network such as a global positioning system (GPS) network. Examples of communication units 42 include a network interface card (e.g. such as an Ethernet card), an optical transceiver, a radio frequency transceiver, or any other type of device that can send and/or receive information. Other examples of communication units 42 may include Near-Field Communications (NFC) units, Bluetooth® radios, short wave radios, cellular data radios, wireless network (e.g., Wi-Fi®) radios, as well as universal serial bus (USB) controllers.

One or more storage devices 46 may be operable, in the example of FIG. 2, to store information for processing during operation of social network server system 28. In some examples, storage devices 46 may represent temporary memory, meaning that a primary purpose of storage devices 46 is not long-term storage. For instance, storage devices 50 of social network server system 28 may be volatile memory, configured for short-term storage of information, and therefore not retain stored contents if powered off. Examples of volatile memories include random access memories (RAM), dynamic random access memories (DRAM), static random access memories (SRAM), and other forms of volatile memories known in the art.

Storage devices 46, in some examples, also represent one or more computer-readable storage media. That is, storage devices 46 may be configured to store larger amounts of information than a temporary memory. For instance, storage devices 46 may include non-volatile memory that retains information through power on/off cycles. Examples of non-volatile memories include magnetic hard discs, optical discs, floppy discs, flash memories, or forms of electrically programmable memories (EPROM) or electrically erasable and programmable (EEPROM) memories. In any case, storage devices 46 may, in the example of FIG. 2, store program instructions and/or data associated with modules 30 and 48 and social networking service 32.

Social network server system 28 may, in the example of FIG. 2, receive a request to post a social media message to social networking service 32. For instance, one of communication units 46 may receive data from computing device 2 via network 26 (e.g., a wireless network or cellular network). Communications units 46 may provide the received data to one or more of application modules 10 that are designated (e.g., previously designated by a user) to handle the received data, such as social network server system 28.

The received data may include an indication of the social media message as well as indications of context data associated with the social media message. The indication of the social media message may include an indication of content 14 of the social media message, which may include textual content, audiovisual content, and the like. In some examples, the indication of the social media message may be the social media message that is to be posted at social networking service 32. The indications of context data associated with the social media message may include an indication of the author (i.e., the user) of the social media message, an indication of the intended audience of the social media message, the geographic location of the computing device from which the social media message originates, the inferred activity of the user when the user composed or sent the social media message, the time at which the user composed or sent the social media message, and the like.

Social networking service 32 may receive the indication of the social media message and may, prior to posting the social media message at social networking service 32, utilize rules module 30 to determine whether to generate an alert message indicating that content 14 of the social media message is likely to be modified by the user (e.g., the author of the social media message) after it is posted at social networking service 32. If rules module 30 determines that the likelihood that the user would modify the content of the social media message after it is posted at the social networking service 32 exceeds a specified threshold, then social networking service 32 may refrain from posting the social media message and may generate an alert message to be sent to the computing device from which the social media message originates (e.g., computing device 2) to alert the user that the social media message may include offensive, embarrassing, or personally sensitive content, so that the user may choose to refrain from posting the social media message at social networking service 32.

If rules module 30 determines that the likelihood that the user would modify the content of the social media message after it is posted at the social networking service 32 does not exceed the specified threshold, then social networking service 32 may post the social media message at social networking service 32. Alternatively, if social networking service 32, after generating the alert message that is sent to the computing device from which the social media message originates, receives, from the computing device from which the social media message originates, an indication of a confirmation of the request to post the social media message, then social networking service 32 may also post the social media message at social networking service 32.

Posting the social media message social networking service 32 may include processing the social media message to make the social media message available to be viewed by users of social networking service 32 that are members of the intended audience of the social media message. Social networking service 32 may store the social media message into social network data store 50A as a social media message associated with the user who authored the message, modify viewing permissions of the social media message so it is viewable only to users that are members of the intended audience of the social media message, and the like. In this way, the social media message is added into the social message feed or timeline of the user in social networking service 32 and is available to be viewed at social networking service 32 by the intended audience.

Modifying the social media message may include editing at least a portion of content 14 of the social media message. Modifying the social media message may also include deleting the social media message from social networking service 32. Deleting a social media message may include acting to remove the social media message from social networking service 32 or acting so that the social media message is not viewable to other users of social networking service 32.

Rules module 30 may analyze a social media message against a set of rules stored in rules data store 50B to determine the likelihood that the user who authored the message would modify the content of the social media message after it is posted at social networking service 32. The set of rules may specify characteristics of social media messages that may indicate that these social media messages may be relatively more likely to be modified by the user after being posted to social networking service 32.

In some examples, the set of rules may include rules regarding any textual content that may be included in the social media message, so that rules module 30 may determine the likelihood based at least in part on textual content of the social media message. The rules may specify words or phrases that are potentially offensive, embarrassing, or otherwise casts the writer of those words or phrases in a negative light. Those words or phrases may include, e.g., swear words and phrases, potentially hateful or hurtful words or phrases, words and phrases that may potentially be racist and/or sexist, and the like. The words or phrases may also be personal information of the user that should not be available for viewing by others. Examples of these words or phrases may include credit card numbers, social security numbers, possible passwords, and the like. In some examples, rules module 30 may assign scores to the words or phrases specified by the rules. These scores may correspond to the probability that a user is likely to modify a social media message that includes the associated words or phrases or to modify the social media message to delete the associated words or phrases.

Rules module 30 may apply these rules against content 14 of the social media message to determine whether the textual content of the social media message contains any of the words, phrases, or other text specified by these rules. In some examples, rules module 30 may score the social media message based at least in part on matching the words and phrases specified by the rules. Rules module 30 may score the social media message based on the associated scores of the words or phrases in the social media message that are specified by the rules.

In some examples, the set of rules may include rules regarding any media content (e.g., images, videos, and audio) that may be included in the social media message. The rules may specify characteristics of media content that may potentially be personally sensitive or that are potentially offensive, embarrassing, or otherwise casts the user that includes such content into their social media messages in a negative light. For example, a rule may specify that an image is deemed to be offensive or embarrassing if over 90% of the pixels of the image is flesh colored. Another example rule may specify that an audio clip is deemed to be offensive or embarrassing if the audio clip includes audible swear words or phrases.

Rules module 30 may apply these rules against content 14 of the social media message to determine whether the media content included in the social media message contains any of these characteristics specified by these rules. In some examples, rules module 30 may score the social media message based at least in part on matching the characteristics specified by the rules. Rules module 30 may score the social media message based on the associated scores of the characteristics of the media content in the social media message that are specified by the rules.

In some examples, the set of rules may also include rules regarding contextual information associated with the social media message, such as the time at which the social media message was composed, the location of the user at the time at which the social media message was composed, and the like. For example, a rule may combine the contextual information associated with the social media message as well as the content or characteristics of the content of the social media message to score the likelihood that a user is likely to modify the social media message after it has been posted. A rule, for instance, may be associated with a relatively high score corresponding with a high probability that a user is likely to modify the social media message if the social media message was composed by the user between midnight and 7 am, if the user is at a bar, and if the social media message includes an image where over 90% of the pixels of the image is flesh colored.

Rules module 30 may generate the set of rules that are applied to social media messages composed or generated by a user of social networking service 32 in any number of ways. In one example, an administrator of social networking service 32 may manually generate one or more of the set of rules. For example, the administrator may manually create a black list of words or phrases that are offensive, embarrassing, or otherwise break the terms of service of social networking service 32. The administrator may similarly manually create rules that detect pornographic or illegal images and video content.

In these examples, if rules module 30 determines that a social media message includes one of the blacklisted words or phrases, or if the social media message includes such images or video content, rules module 30 may determine that the likelihood that the user who authored the message would delete or otherwise modify the content of the social media message after it is posted at social networking service 32 exceeds a threshold, and may generate an alert message to be sent to the computing device of the user. In some examples, social networking service 32 would prevent such a social media message from being posted to social networking service 32 unless the offending content was removed from the social media message.

In some examples, rules module 30 may determine the set of rules that are applied to a social media message based at least in part on the intended audience of the social media message as specified by the user, because certain content of a social media message may be potentially embarrassing or offensive if viewed by one set of users but may not be potentially embarrassing or offensive if viewed by another, different set of users. In one example, if the intended audience of a social media message include users that are deemed to be close friends of the author of the social media message, then rules module 30 may refrain from applying rules that specify swear words to the social media message. In this way, rules module 30 may not increase the likelihood that the user who authored the message would modify the content of the social media message after it is posted at social networking service 32 if the content of the social media message contains swear words specified by those rules. In contrast, if the intended audience of the social media message include users that are deemed to be co-workers of the author of the social media message, rules module 30 may apply those rules that specify swear words to the social media message. Thus, whether a rule is applied to a social media message may also depend upon the intended audience of the social media message. In some examples, each of the set of rules may be associated with a set of one or more intended audiences, so that each of the set of rules may only be applied to a social media message that is viewable to at least one of the one or more intended audiences associated with the respective rule.

In one example, rules module 30 may generate one or more of the set of rules for a user based at least in part on the previous behavior of the user in interacting with social networking service 32, such as the previous actions taken by the user on previous social media messages authored by the user and posted at social networking service 32. Such previous actions taken by the user may include modifying the content of the previous social media messages or deleting the previous social media messages. Rules module 30 may generate one or more of the set of rules for a user based at least in part on the social media messages that the user had previously posted at social networking service 32 and then had later modified or deleted. Rules module 30 may generate such one or more of the rules based on the content of those previously posted social media messages, the contextual information related to the social media messages, such as the location of the user when the user composed or posted the social media messages, the activity the user was engaged in when composing or posting the social media messages, and the like.

In some examples, rules module 30 may generate one or more of the set of rules for a user based at least in part on previous social media messages that were posted at social networking service 32 and then later deleted by the user within a timeframe after posting the respective previous social media messages. If a user modifies a social media message shortly after posting the social media message to social networking service 32, it may be likely that the social media message contained content that was embarrassing, offensive, or personally sensitive. On the other hand, if a user modifies a social media message years after posting the social media message to social networking service 32, it may be more likely that the user modified the social media message for reasons other than it potentially containing content that was embarrassing, offensive, or personally sensitive. Thus, in some examples, the timeframe within a user modifies a previous social media message may be a day, 8 hours, an hour, and the like, and rules module 30 may generate one or more of the set of rules for a user based at least in part on previous social media messages that were posted at social networking service 32 and then later deleted by the user within that specific timeframe.

Such a log of a user's history may be stored in social network data store 50A. The log of the user's history is secured, such as via encryption, in social network data store 50A, and may be managed by the user, so that the user can delete the log or restrict whether rules module 30 has access to the log. In some examples, rules module 30 may output a warning message prior to usage of the log of the user's history, so that the user can explicitly permit or deny rules module 30 access to the log. In some examples, social networking service 30 may not store a log of the user's history into social network data store 50A unless the user explicitly opts into the storage of user history. In some examples, the log of the user's history are deleted from social network data store 50A at regular intervals, such as every day, every week, every month, and the like.

Rules module 30 may utilize training module 48 to perform machine learning over social media messages that the user had previously posted at social networking service 32 and then had later modified, to learn the characteristics of social media messages that makes the user likely to later modify the post, and to generate one or more of the set of rules for the user. By performing machine learning over those social media messages, training module 48 may generate a machine-trained model to be able to determine, for a social media message, the likelihood that a user will later modify (e.g., delete) the social media message after posting the social media message at social networking service 32 based at least in part on whether the social media message contains the characteristics learned over social media messages that the user had previously posted at social networking service 32 and then had later modified.

Rules module 30 may utilize any suitable machine learning model to perform machine learning over social media messages that the user had previously posted at social networking service 32 and then had later modified. In one example, rules module 30 may use a decision tree that may be trained given the content of the social media messages that the user had previously posted at social networking service 32 and then had later modified. In this example, rules module 30 may train the model over those social media messages to recognize certain words, phrases, media content (e.g., audiovisual) characteristics, and the like contained in the content of those social media messages that tend to make those social media messages more likely to be later modified by the user. Thus, instead of having a user manually specify words, phrases, media content characteristics, and the like, rules module 30 may create one or more of the set of rules that specify such words, phrases, characteristics, and the like via machine learning to train a model over social media messages that the user had previously posted at social networking service 32 and then had later modified.

In another example, rules module 30 may alternatively, or in addition to the decision tree, use a neural network that models the behavior of the user that takes into consideration different signals over time. One non-exclusive example of a neural network is a recurrent neural network. In addition to the content of the social media messages that the user had previously posted at social networking service 32 and then had later modified or deleted from social networking service 32, the neural network may capture time-dependent action. Thus, in addition to rules regarding the content of a social media message, the neural network may be able to generate rules based on contextual information associated with the social media message, such as the user's location across time (e.g., a venue), the user's activity across time (e.g., if the user is playing a game), as well as the user's final action (e.g., posting a social media message at social networking service 32). Such generating of rules based on contextual information associated with the social media message may also be performed via any other suitable machine learning technique, such as the decision tree described above.

Each of the rules generated by rules module 30 may be associated with a score that corresponds to a function of the probability that, if a social media message matches the characteristics specified by a rule, the user that authored the social media message would modify the social media message after it is posted at social networking service 32. For example, training module 48 may encounter multiple previous social media messages of the user that contains a specific phrase, where the social media message was posted by the user while the user was detected as being at a point of interest or geographical location (e.g., a restaurant). Training module 48 may also determine that only 20% of those previous social media messages having those characteristics were later deleted by the user within one day of posting those social media messages. In this example, training module 30 may generate a rule that specifies those characteristics and may assign a score that corresponds to a 20% chance that, if a social media message matches the characteristics specified by a rule, the user that authored the social media message would modify the social media message after it is posted at social networking service 32.

The result of performing machine learning over social media messages that the user had previously posted at social networking service 32 and then had later modified may be rules module 30 generating a machine-trained model that may be able to determine the likelihood that a social media message from a user, if posted at social networking service 32, will be later modified by the user. Rules module 30 may input a social media message from the user into the model, and the model may analyze the social media message to output a score that corresponds to the likelihood that the user would modify the content of the social media message after it is posted at social networking service 32. In this way, rules module 30 may utilize training module 48 to generate a machine-trained model as the one or more of the set of rules for a user based at least in part on the previous actions taken by the user at social networking service 32.

Similarly, rules module 30 may generate one or more of the set of rules for a user based at least in part on the previous behavior of a plurality of users of the social networking service 32. Rules module 30 may generate one or more of the set of rules for a user based at least in part on previous actions taken by the plurality of users of social networking service 32 on previous social media messages authored by the plurality of users and posted at social networking service 32. Rules module 30 may generate such one or more of the rules based on the content of those previously posted social media messages, the contextual information related to the social media messages, such as the location of the user of the plurality of users when the user composed or posted the social media messages, the activity the user of the plurality of users was engaged in when composing or posting the social media messages, and the like.

The plurality of users may be two or more users of the social networking service 32. In some examples, the social networking service 32 may enable its users to opt in to belonging to the plurality of users. In some examples, social networking service 32 may explicitly alert users of the social networking service 32 that their previous behavior at social networking service 32 may be analyzed, and may provide an option for users to opt out. Thus, the plurality of users may comprise users of social networking service 32 that have not opted out of, or that have opted into having their previous activity at social networking service 32 analyzed to create the set of rules.

Social networking service 32 may capture the previous behavior of a plurality of users of the social networking service 32 in logs stored in social network data store 50A. Such logs may be encrypted and may also be anonymized to minimize the chances that a user can be identified based on the information stored in the logs. Social networking service 32 may remove all personal information identifying individual users, replace any user IDs with randomly assigned IDs, and/or employ any suitable differential privacy mechanisms to anonymize the data contained within the logs. At any time, a user may opt out of having its information collected in the logs. Social networking service 32 may delete the user's information from the logs upon the user opting out of having its information collected in the logs. Alternatively, in some examples, social networking service 32 may not collect user information unless the user has explicitly opted in to such data collection.

Rules module 30 may utilize training module 48 to perform machine learning over social media messages authored by the plurality of users that were posted at social networking service 32 and then later modified by one or more of the plurality of users, to learn the characteristics of social media messages that potentially makes the users likely to later modify the posts, and to generate one or more of the set of rules. By performing machine learning over those social media messages, training module 48 may generate a machine-trained model to be able to determine, for a social media message, the likelihood that the user that composed the social media message will later modify (e.g., delete) the social media message after posting the social media message at social networking service 32. Such a determination may be based at least in part on whether the social media message contains the characteristics learned over social media messages that the plurality of users had previously posted at social networking service 32 and then had later modified.

Rules module 30 may utilize any suitable machine learning model to perform machine learning over social media messages that the plurality of users had previously posted at social networking service 32 and then had later modified. In one example, rules module 30 may use a decision tree that may be trained given the content of the social media messages that the plurality of users had previously posted at social networking service 32 and then had later modified. In this example, rules module 30 may train the model over those social media messages to recognize certain words, phrases, audiovisual characteristics, and the like contained in the content of those social media messages that tend to make those social media messages more likely to be later modified by the plurality of users. Thus, instead of having a user manually specify words, phrases, media content characteristics, and the like, rules module 30 may create one or more of the set of rules that specify such words, phrases, audiovisual characteristics, and the like via machine learning to train a model over social media messages that the plurality of users had previously posted at social networking service 32 and then had later modified.

In another example, rules module 30 may use a neural network that models the behavior of the plurality of users that takes into consideration different signals over time. In both the decision tree and the neural network, in addition to the content of the social media messages that the plurality of users had previously posted at social networking service 32 and then had later modified or deleted from social networking service 32, the recurrent neural network may capture time-dependent action. Thus, in addition to rules regarding the content of a social media message, the recurrent neural network may be able to generate rules based on contextual information associated with the social media message, such as the plurality of users' locations across time (e.g., a venue), the plurality of users' activities across time (e.g., if the user is playing a game), as well as the plurality of users' final actions (e.g., posting a social media message at social networking service 32).

Each of the rules generated by rules module 30 may be associated with a score that corresponds to a function of the probability that, if a social media message matches the characteristics specified by a rule, the user that authored the social media message would modify the social media message after it is posted at social networking service 32. For example, training module 48 may encounter multiple previous social media messages of the plurality of users that contains a specific phrase, where the social media message was posted by the users while the users were detected as being at a point of interest or geographical location (e.g., a restaurant). Training module 48 may also determine that only 20% of those previous social media messages having those characteristics were later deleted by the users within one day of posting those social media messages. In this example, training module 30 may generate a rule that specifies those characteristics and may assign a score that corresponds to a 20% chance that, if a social media message matches the characteristics specified by a rule, the user that authored the social media message would modify the social media message after it is posted at social networking service 32.

The result of performing machine learning over social media messages that the plurality of users had previously posted at social networking service 32 and then had later modified may be rules module 30 generating a machine-trained model that may be able to determine the likelihood that a social media message from a user of social networking service 32, if posted at social networking service 32, will be later modified by the user. Rules module 30 may input a social media message from a user into the model, and the model may analyze the social media message to output a score for the social media message that corresponds to the likelihood that the social media message, if posted at social networking service 32, will be later modified by the user. In this way, rules module 30 may utilize training module 48 to generate a machine-trained model as the one or more of the set of rules for a user based at least in part on the previous actions taken by the user at social networking service 32.

The model may be used by rules module 30 to analyze the social media message created by any user of social networking service 32 to determine the likelihood that the social media message, if posted at social networking service 32, will be later modified by the user. In fact, the model may be used to determine the likelihood that a social media message created by a user, if posted at social networking service 32, will be later modified by the user, regardless of whether the user is part of the plurality of users that had its previous behavior at social networking service 32 analyzed to create the model.

Rules module 32 may use any combination of the one or more rules that are manually generated by an administrator or operator of social networking service 32, the one or more rules generated based at least in part on previous actions taken by the user at social networking service 32, and the one or more rules generated based at least in part on previous actions taken by a plurality of users at social networking service 32. In some examples, rules module 32 may only use the one or more rules that are manually generated by an administrator or operator of social networking service 32. In some examples, rules module 32 may use the one or more rules that are manually generated by an administrator or operator of social networking service 32 along with the one or more rules generated based at least in part on previous actions taken by the user at social networking service 32. In some examples, rules module 32 may use the one or more rules that are manually generated by an administrator or operator of social networking service 32 along with the one or more rules generated based at least in part on previous actions taken by a plurality of users at social networking service 32.

Rules module 30 may apply the set of rules to a social media message to generate a score for the social media message that corresponds with the likelihood that a user is likely to modify the social media message after it has been posted. Rules module 30 may compare the score for the social media message with a threshold. If rules module 30 determines that the score for the social media message exceeds the threshold, then rules module 30 may enable social networking service 32 to generate an alert message to alert the user that the user is likely to modify the social media message. The threshold may be a numerical value, a percentage value, or the like and may correspond with a high likelihood that a user is likely to modify a social media message after it has been posted to social networking service 32. In one example, the threshold may be 0.75, which may correspond with a 75% likelihood that a user is likely to modify a social media message after it has been posted to social networking service 32. In other examples, the threshold may be an integer value such as 20, a percentage value such as 80%, or any other suitable value. Such a threshold may be manually determined and set by an administrator or operator. The threshold may also be set based on the scores of social media messages that were posted at social networking service 32 and then later modified or deleted by a user. For example, the threshold may be an average (e.g., mean or median) of the scores of those social media messages. For example, if the mean score of previous social media messages that were posted at social networking service 32 and then later modified or deleted by a user was 0.8 (out of, e.g., 1), social networking service 32 may set the threshold to 0.8, or to a certain percentage of 0.8 (e.g., 90% of 0.8).

As discussed above, each rule may be associated with a score that corresponds with the likelihood that a social media message that matches the rule would be modified by the user after it has been posted at social networking service 32. Thus, rules module 30 may generate the score for the social media message based at least in part on applying the set of rules to the social media message and determining whether the social media message matches the set of rules.

In some examples, a rule may have an associated score, and if a social media message matches the characteristics specified by the rule, then the score associated with the rule is added to the score for the social media message. For example, a rule that specifies one or more offensive words or phrases may specify a score of 1.0 if the textual content of a social media message matches any one of the one or more offensive words or phrases specified by the rule. If the social media message matches any one of the one or more offensive words or phrases, rules module 30 may add the score of 1.0 to the score for the social media message. In some examples, a score of 1.0 may exceed the threshold, so that the score for the social media message may exceed the threshold even if the social media message only contains a single offensive word or phrase specified by the rule.

In other examples, rules module 30 may add a score that is less than the threshold to the score for the social media message for each offensive word or phrase specified by the rule that is contained by the social media message. Rules module 30 may associate a score with each offensive word or phrase specified by the rule, where each of the associated scores is less than the threshold. In this instance, the score for the social media message may not necessarily exceed the threshold if the social media message only contains a single offensive word or phrase specified by the rule. However, the score for the social media message may exceed the threshold if the social media message two or more of the offensive words or phrases specified by the rule.

As discussed above, rules module 30 may apply any suitable combination of rules to a social media message to determine the likelihood that a user would modify a social media message after it has been posted at social networking service 32. For example, rules module 30 may first apply one or more manually generated rules. The one or more manually generated rules may specify a black list of words or phrases that are, e.g., offensive, embarrassing, or otherwise break the terms of service of social networking service 32. Rules module 30 may associate a score for each of the words or phrases in the black list, so that each score exceeds the threshold. In this instance, the score for each of the words or phrases in the black list may exceed the threshold. Thus, if the social media message contains even a single word or phrase that is included in the black list specified by the one or more manually generated rules, the score for the social media message may exceed the threshold.

In addition, or alternatively to applying the one or more manually generated rules, rules module 30 may, in some examples, apply one or more rules that are generated by rules module 30 base at least in part on previous actions taken by the user on previous social media messages authored by the user and posted at social network service 32. Specifically, rules module 30 may generate the one or more rules based at least in part on social media messages that were previously posted to social networking service 32 by the user and then later modified by the user.

If rules module 30 had already previously applied the one or more manually generated rules that specified a black list of words or phrases, rules module 30 may, in some examples, apply the one or more rules that are generated by rules module 30 base at least in part on previous actions taken by the user on previous social media messages authored by the user and posted at social network service 32 only if the social media message did not include any of the words or phrases specified by the one or more manually generated rules. This may be the case if the score associated with matching just one of the words or phrases specified by the one or more manually generated rules exceeds the threshold. In some examples, if the score for the social media message after applying the one or more manually generated rules does not exceed the threshold, then rules module may apply the one or more rules that are generated by rules module 30 base at least in part on previous actions taken by the user on previous social media messages authored by the user and posted at social network service 32 even if the social media message includes one or more of the words or phrases specified by the one or more manually generated rules.

To apply the one or more rules that are generated by rules module 30 base at least in part on previous actions taken by the user on previous social media messages authored by the user and posted at social network service 32 to a social media message, rules module 30 may input the social media message into a machine-trained model that has been trained by training module 48 based at least in part on the previous actions taken by the user on previous social media messages authored by the user and posted at social network service 32. The machine-trained model may, in response to receiving the social media message, generate the score for the social media message. For example, the machine trained model may determine whether the social media message matches one or more characteristics of social media messages that were previously posted to social networking service 32 by the user and then later modified by the user, as previously learned by the machine-trained model, and may assign a score for the social media message based on how well the social media message matches the one or more characteristics.

In addition, or alternatively to applying one or more rules that are generated by rules module 30 based at least in part on previous actions taken by the user on previous social media messages authored by the user and posted at social network service 32 to a social media message, rules module 30 may also apply to a social media message one or more rules that are generated based at least in part on previous actions taken by a plurality of other users of social networking service 32 on previous social media messages authored by the plurality of other users and posted at social networking service 32. Specifically, rules module 30 may generate the one or more rules based at least in part on social media messages that were previously posted to social networking service 32 by a plurality of other users and then later modified by one or more of the plurality of other users.

To apply the one or more rules that are generated by rules module 30 based at least in part on previous actions taken by a plurality of other users on previous social media messages authored by the plurality of other users and posted at social network service 32 to a social media message, rules module 30 may input the social media message into a machine-trained model that has been trained based at least in part on the previous actions taken by the plurality of other users on previous social media messages authored by the plurality of users and posted at social network service 32. The machine-trained model may, in response to receiving the social media message, generate the score for the social media message. For example, the machine trained model may determine whether the social media message matches one or more characteristics of social media messages that were previously posted to social networking service 32 by the plurality of other users and then later modified by one or more of the plurality of other user, as previously learned by the machine trained model, and may assign a score for the social media message based on how well the social media message matches the one or more characteristics.

As discussed herein, rules module 30 may apply a set of rules to calculate a score for a social media message that corresponds to the likelihood that the user that created the social media message would modify the content of the social media message after it is posted at social networking service 32. Upon generating the score for the social media message, social networking service 32 may compare the score with a threshold value that corresponds to a relatively high likelihood that the user that created the social media message would modify the content of the social media message after it is posted at social networking service 32. Thus, if the score for the social media message exceeds the threshold value, social networking service 32 may deem the social media message to have a high likelihood of being modified by the user who created the social media message after it is posted at social networking service 32.

Responsive to determining that the social media message has a high likelihood of being modified by the user who created the social media message after it is posted at social networking service 32, social networking service 32 may refrain from posting the social media message to social networking service 32. Social networking service 32 may also generate an alert message to be sent to the computing device (e.g., computing device 2) of the user to notify the user that the user is likely to modify the social media message after it is posted at social networking service 32, and to provide the user an opportunity to refrain from posting the social media message to social networking service 32. The alert message may be any suitable data that is communicated by social network server system 28 through network 26 to the computing device from which the social networking message originated (e.g., computing device 2). In this way, social networking service 32 may reduce the number of extraneous social media messages that are posted at social networking service 32 and then later edited or removed from social networking service 32, thereby improving the computing efficiency of social network server system 28, as discussed above.

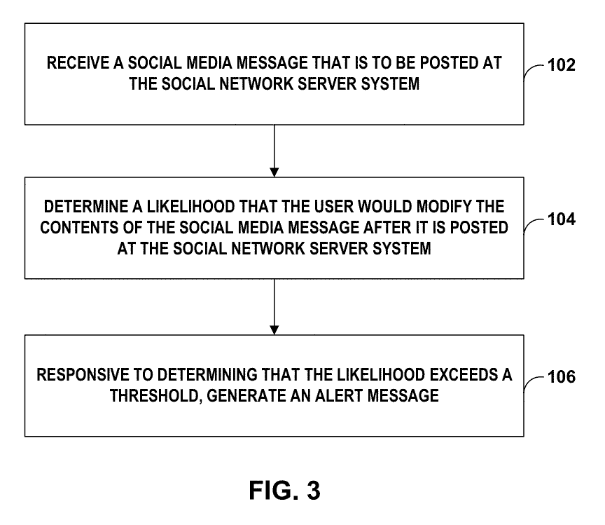

FIG. 3 is a flow diagram illustrating example operations of a social network server system that may be configured to determine whether the user that authored the social media message is likely to later modify the social media message, in accordance with one or more techniques of the present disclosure. For purposes of illustration only, the example operations of FIG. 3 are described below within the context of FIGS. 1 and 2. In the example of FIG. 3, a social network server system 28 may receive (102) a social media message that is to be posted at the social network server system 28, the social media message being authored by a user of the social network server system 28. In some examples, a social media message that is to be posted at social network server system 28 may be a social media message that is to be posted at social networking service 32 that executes at social network server system, and a user of the social network server system 28 may be a user of social networking service 32 that executes at social network server system 28.

Prior to posting the social media message at the social network server system 28: social networking server system 28 may determine (104), based at least in part on applying one or more rules to content of the social media message, a likelihood that the user would modify the content of the social media message after it is posted at the social network server system 28. The one or more rules are generated based at least in part on previous actions taken by the user on previous social media messages authored by the user and posted at the social network server system 28. Responsive to determining that the likelihood exceeds a threshold, the social network server system may generate (106) an alert message.

In some examples, determining the likelihood that the user would modify the content of the social media message after it is posted at the social network server system 28 comprises determining, by social network server system 28, the likelihood that the user would delete the social media message from the social network server system 28 after it is posted at the social network server system 28. In some examples, the one or more rules are generated based at least in part on previous social media messages authored by the user that were posted at the social networking service and then later modified by the user.

In some examples, the social network server system 28 may generate the one or more rules by machine training a model based at least in part on the previous social media messages authored by the user that were posted at the social network server system 28 and then later modified by the user. In some examples, determining the likelihood that the user would modify the content of the social media message after it is posted at the social network server system 32 may include the social network server system 28 inputting the social media message into the model and outputting a score for the social media message that corresponds to the likelihood that the user would modify the content of the social media message after it is posted at the social network server system 32 from the model executing at the social network server system 32.

In some examples, determining the likelihood that the user would modify the content of the social media message after it is posted at social network server system 32 is based at least in part on one or more of: textual content of the social media message, contextual information associated with the social media message, and an intended audience for the social media message.

In some examples, the one or more rules comprise a first one or more rules, and determining the likelihood that the user would modify the content of the social media message after it is posted at the social network server system 32 is further based at least in part on applying second one or more rules to the content of the social media message, and wherein the second one or more rules are generated based at least in part on previous actions taken by a plurality of users of the social network server system 32 on previous social media messages authored by the plurality users and posted at the social network server system 32.

In some examples, the one or more rules are generated based at least in part on previous social media messages authored by the plurality of users that were posted at the social network server system 28 and then later modified by one or more of the plurality of users. In some examples, the social network server system 28 may further generate the second one or more rules by machine training a model based at least in part on the previous social media messages authored by the plurality of users that were posted at the social network server system 28 and then later modified by one or more of the plurality of users. In some examples, determining the likelihood that the user would modify the content of the social media message after it is posted at the social network server system 32 may include the social network server system 28 inputting the social media message into the model and outputting a score for the social media message that corresponds to the likelihood that the user would modify the content of the social media message after it is posted at the social network server system 32 from the model executing at the social network server system 32.

In some examples, determining the likelihood that the user would modify the content of the social media message after it is posted at the social network server system 32 is further based at least in part on applying a third one or more rules to the content of the social media message, wherein the third one or more rules are manually generated.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media, which includes any medium that facilitates transfer of a computer program from one place to another, e.g., per a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable storage medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
receiving, by a social network server system, a social media message that is to be posted at the social network server system, the social media message being authored by a user of the social network server system;
prior to posting the social media message at the social network server system:
determining, by the social network server system, and based at least in part on applying one or more rules to content of the social media message, a likelihood that the user would modify the content of the social media message after it is posted at the social network server system, wherein the one or more rules are generated based at least in part on previous actions taken by the user on previous social media messages authored by the user and posted at the social network server system; and
responsive to determining that the likelihood exceeds a threshold, generating, by the social network server system, an alert message.

2. The method of claim 1, wherein determining the likelihood that the user would modify the content of the social media message after it is posted at the social network server system comprises determining, by the social network server system, a likelihood that the user would delete the social media message from the social network server system after it is posted at the social network server system.

3. The method of claim 1, wherein the one or more rules are generated based at least in part on the previous social media messages authored by the user that were posted at the social network server system and then later modified by the user.

4. The method of claim 3, further comprising:
generating, by the social network server system, the one or more rules by machine training a model based at least in part on the previous social media messages authored by the user that were posted at the social networking server system and then later modified by the user.

5. The method of claim 4, wherein determining the likelihood that the user would modify the content of the social media message after it is posted at the social network server system comprises:
inputting, by the social network server system, the social media message into the model executing at the social network server system; and
receiving, by the social network server system, a score for the social media message that is output by the model, wherein the score corresponds to the likelihood that the user would modify the content of the social media message after it is posted at the social network server system.

6. The method of claim 1, wherein determining the likelihood that the user would modify the content of the social media message after it is posted at social network server system is based at least in part on one or more of:
textual content of the social media message,
contextual information associated with the social media message, and
an intended audience for the social media message.

7. The method of claim 1, wherein the one or more rules comprise first one or more rules, wherein determining the likelihood that the user would modify the content of the social media message after it is posted at the social network server system is further based at least in part on applying second one or more rules to the content of the social media message, and wherein the second one or more rules are generated based at least in part on previous actions taken by a plurality of users of the social network server system on previous social media messages authored by the plurality users and posted at the social network server system.

8. The method of claim 7, wherein the one or more rules are generated based at least in part on the previous social media messages authored by the plurality of users that were posted at the social network server system and then later modified by one or more of the plurality of users.

9. The method of claim 8, further comprising:
generating, by the social network server system, the second one or more rules by machine training a model based at least in part on the previous social media messages authored by the plurality of users that were posted at the social network server system and then later modified by one or more of the plurality of users.

10. The method of claim 9, wherein determining the likelihood that the user would modify the content of the social media message after it is posted at the social network server system comprises:
inputting, by the social network server system, the social media message into the model executing at the social network server system; and
receiving, by the social network server system, a score for the social media message that is output by the model, wherein the score corresponds to the likelihood that the user would modify the content of the social media message after it is posted at the social network server system.

11. The method of claim 1, wherein the one or more rules comprise first one or more rules, wherein determining the likelihood that the user would modify the content of the social media message after it is posted at the social network server system is further based at least in part on applying third one or more rules to the content of the social media message, wherein the third one or more rules are manually generated.

12. A social network server system, comprising:
a non-transitory computer-readable storage medium;
at least one processor communicatively coupled to the computer-readable storage medium, the at least one processor being configured to:
receive a social media message that is to be posted at the social network server system, the social media message being authored by a user of the social network server system;
prior to posting the social media message at the social network server system:
determine, based at least in part on applying one or more rules stored in the non-transitory computer-readable storage medium to content of the social media message, a likelihood that the user would modify the content of the social media message after it is posted at the social network server system, wherein the one or more rules are generated based at least in part on previous actions taken by the user on previous social media messages authored by the user and posted at the social network server system; and
responsive to determining that the likelihood exceeds a threshold, generate an alert message.

13. The social network server system of claim 12, wherein the one or more rules are generated based at least in part on the previous social media messages authored by the user that were posted at the social network server system and then later modified by the user.

14. The social network server system of claim 13, wherein the at least one processor is further configured to:
generate the one or more rules by machine training a model based at least in part on the previous social media messages authored by the user that were posted at the social networking server system and then later modified by the user.

15. The social network server system of claim 14, wherein the at least one processor is further configured to:
input the social media message into the model executing at the social network server system; and
receive a score for the social media message that is output by the model, wherein the score corresponds to the likelihood that the user would modify the content of the social media message after it is posted at the social network server system.

16. The social network server system of claim 12, wherein the one or more rules comprise a first one or more rules, and wherein the at least one processor is further configured to:
determine the likelihood that the user would modify the content of the social media message after it is posted at the social network server system based further at least in part on applying second one or more rules to the content of the social media message, wherein the second one or more rules are generated based at least in part on previous actions taken by a plurality of users of the social network server system on previous social media messages authored by the plurality users and posted at the social network server system.

17. A non-transitory computer readable medium encoded with instructions that, when executed, cause one or more processors of a social network server system to:
receive a social media message that is to be posted at the social network server system, the social media message being authored by a user of the social network server system; and
prior to posting the social media message at the social network server system:
determine, based at least in part on applying one or more rules to content of the social media message, a likelihood that the user would modify the content of the social media message after it is posted at the social network server system, wherein the one or more rules are generated based at least in part on previous actions taken by the user on previous social media messages authored by the user and posted at the social network server system; and
responsive to determining that the likelihood exceeds a threshold, generate an alert message.

18. The non-transitory computer readable medium of claim 17, wherein the one or more rules are generated based at least in part on the previous social media messages authored by the user that were posted at the social network server system and then later modified by the user.

19. The non-transitory computer readable medium of claim 18, wherein the instructions further cause the one or more processors to:
generate the one or more rules by machine training a model based at least in part on the previous social media messages authored by the user that were posted at the social networking server system and then later modified by the user.

20. The non-transitory computer readable medium of claim 19, wherein the instructions further cause the one or more processors to:
input the social media message into the model executing at the social networker server system; and
receive a score for the social media message that is output by the model, wherein the score corresponds to the likelihood that the user would modify the content of the social media message after it is posted at the social network server system.
